(19) United States
(12) Patent Application Publication
(10) Pub. No.: US 2025/0203430 A1
(43) Pub. Date: Jun. 19, 2025

(54) APPARATUS AND METHOD FOR MEASURING CROSS LINK INTERFERENCE AND RECEIVING DOWNLINK SIGNAL IN A WIRELESS NETWORK

(71) Applicant: QUALCOMM Incorporated, San Diego, CA (US)

(72) Inventors: Yuwei REN, Beijing (CN); Liangming WU, Beijing (CN); Huilin XU, Temecula, CA (US)

(21) Appl. No.: 18/847,762

(22) PCT Filed: Apr. 24, 2022
(86) PCT No.: PCT/CN2022/088750

§ 371 Date: Sep. 17, 2024

(51) Int. Cl. H04W 24/10; H04B 7/06; H04L 27/26; H04W 72/0453; H04W 72/23

(52) U.S. Cl. CPC H04W 24/10; H04B 7/0626; H04L 27/2665; H04W 72/0453; H04W 72/23

(57) ABSTRACT

A UE receives a cross link interference (CLI) signal from an aggressor and a downlink (DL) signal from a network in the same symbol. The UE can use a single fast Fourier transform (FFT) window to receive both CLI signal and DL signal. The UE can use various techniques to avoid skipping DL reception even when a dense CLI measurement pattern is used. The disclosed techniques can reduce resource wastage caused by unnecessary CLI measurements.

### TECHNICAL FIELD

The technology discussed below relates generally to wireless communication systems, and more particularly, to measuring cross link interference and receiving a downlink signal in a wireless communication network.

### INTRODUCTION

In wireless communication, time division duplex (TDD) architecture uses a single frequency band to transmit and receive signals. For example, a TDD wireless network can share the same frequency band and assign alternative time slots for transmitting (downlink) and receiving (uplink) signals, whereas frequency division duplex (FDD) different frequency bands for transmitting and receiving signals. Dynamic TDD allows adaptive configuration and reconfiguration of symbols or time slots between uplink (UL) and downlink (DL). Dynamic TDD enables a network entity (e.g., a base station) to configure symbols/time slots as DL or UL, for example, based on traffic patterns. In some cases, one user equipment (UE) is receiving in a downlink direction, meanwhile, an aggressor (e.g., a neighbor UE) is transmitting in an uplink direction, causing cross link interference (CLI).

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

One aspect of the disclosure provides a user equipment (UE) for wireless communication. The UE includes a transceiver for wireless communication, a memory, and a processor coupled to the transceiver and the memory. The processor and the memory are configured to receive, from a network entity, a downlink (DL) signal using a fast Fourier transform (FFT) window. The processor and the memory are further configured to receive a cross link interference (CLI) signal in the same FFT window. The processor and the memory are further configured to transmit, to the network entity, a CLI measurement report based on the CLI signal.

Another aspect of the disclosure provides a method of wireless communication at a user equipment (UE). The method includes receiving, from a network entity, a downlink (DL) signal using a fast Fourier transform (FFT) window. The method further includes receiving a cross link interference (CLI) signal in the same FFT window. The method further includes transmitting a CLI measurement report based on the CLI signal.

Another aspect of the disclosure provides a network entity for wireless communication. The network entity includes a memory and a processor coupled to the memory. The processor and the memory are configured to transmit a resource configuration of a downlink (DL) signal and a cross link interference (CLI) measurement resource for measuring a CLI signal. The processor and the memory are further configured to transmit the DL signal. The processor and the memory are further configured to receive a CLI report of the CLI signal measured by a user equipment (UE) using a fast Fourier transform (FFT) window in which the DL signal is received.

Another aspect of the disclosure provides a method of wireless communication at a network entity. The method includes transmitting a resource configuration of a downlink (DL) signal and a cross link interference (CLI) measurement resource for measuring a CLI signal. The method further includes transmitting the DL signal. The method further includes receiving a CLI report of the CLI signal measured by a user equipment (UE) using a fast Fourier transform (FFT) window in which the DL signal is received.

These and other aspects of the invention will become more fully understood upon a review of the detailed description, which follows. Other aspects, features, and implementations will become apparent to those of ordinary skill in the art, upon reviewing the following description of specific, exemplary implementations in conjunction with the accompanying figures. While features may be discussed relative to certain examples and figures below, all implementations can include one or more of the advantageous features discussed herein. In other words, while one or more implementations may be discussed as having certain advantageous features, one or more of such features may also be used in accordance with the various examples discussed herein. In a similar fashion, while examples may be discussed below as device, system, or method implementations, it should be understood that such examples can be implemented in various devices, systems, and methods.

### BRIEF DESCRIPTION OF THE DRAWINGS

FIG. 1 is a schematic illustration of a wireless communication system according to some aspects.

FIG. 2 is a schematic illustration of an example of a radio access network according to some aspects.

FIG. 3 is a schematic illustration of an exemplary radio access network including disaggregated network entities according to some aspects.

FIG. 4 is a schematic illustration of an organization of wireless resources in an air interface utilizing orthogonal frequency divisional multiplexing (OFDM) according to some aspects.

FIG. 5 is a schematic illustration of cross link interference (CLI) examples according to some aspects.

FIG. 6 is a flow chart illustrating a process for controlling CLI measurement and downlink (DL) reception according to some aspects.

FIG. 7 is a schematic illustration of exemplary DL resources and CLI measurement resources according to some aspects.

FIG. 8 is a schematic illustration of exemplary DL occasions and CLI occasions according to some aspects.

FIG. 9 is a schematic illustration of exemplary DL resources and CLI measurement resources according to some aspects.

FIG. 10 is a schematic illustration of exemplary physical downlink control channel (PDCCH) and CLI resources according to some aspects.

FIG. 11 is a flow chart illustrating a process for configuring a physical downlink shared channel (PDSCH) and CLI measurement according to some aspects.

FIG. 12 is a schematic illustration of exemplary PDSCH and CLI measurement resources according to some aspects.

FIG. 13 is a flow chart illustrating a process for configuring channel state information (CSI) reporting and CLI measurement according to some aspects.

FIG. 14 is a schematic illustration of exemplary CSI report and CLI measurement resources according to some aspects.

FIG. 15 is a block diagram illustrating an example of a hardware implementation for a network entity according to some aspects.

FIG. 16 is a flow chart illustrating an exemplary process for downlink communication and CLI measurements according to some aspects.

FIG. 17 is a block diagram illustrating an example of a hardware implementation for a scheduled entity according to some aspects.

FIG. 18 is a flow chart illustrating an exemplary process for measuring CLI and receiving DL according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chips and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., network entity and UE), end-user devices, etc. of varying sizes, shapes and constitution.

In various aspects of the disclosure, a UE can receive a cross link interference (CLI) signal from an aggressor and a downlink (DL) signal from a network in the same symbol. The UE can use a single fast Fourier transform (FFT) window to receive both CLI signal and DL signal. The techniques enable the UE to avoid skipping DL reception even when a dense CLI measurement pattern is used. The disclosed techniques also can reduce resource wastage caused by unnecessary CLI measurements.

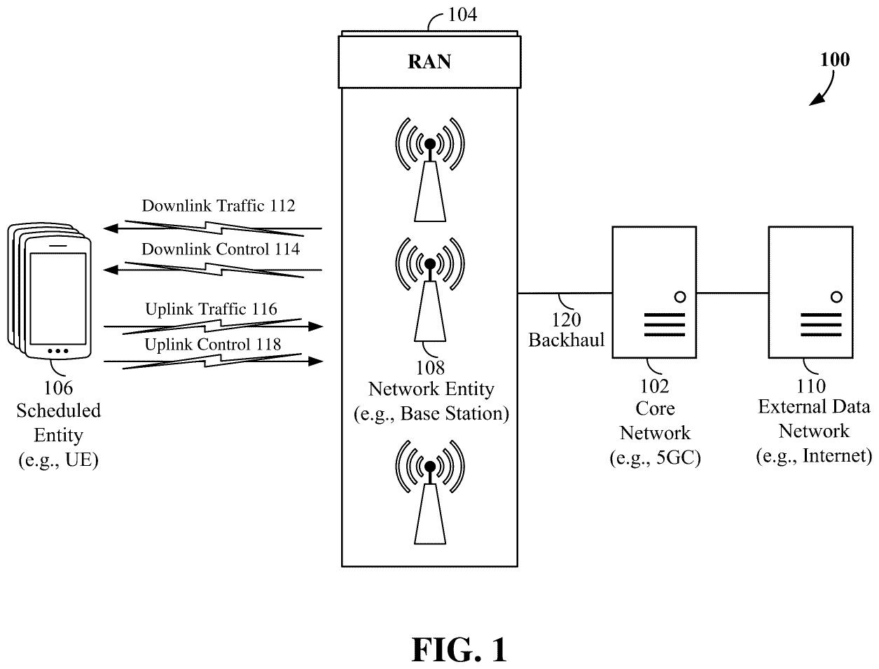

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (CUTRAN) standards, often referred to as Long-Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of network entities (e.g., base stations 108). Broadly, a network entity is a network element in a radio access network responsible for radio transmission and reception in one or more cells to or from a UE. In different technologies, standards, or contexts, a network entity may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), a scheduling entity, or some other suitable terminology. In some examples, a network entity may include two or more TRPs that may be collocated or non-collocated. Each TRP may communicate on the same or different carrier frequency within the same or different frequency band.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, radio frequency (RF) chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a network entity (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a network entity (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic information 112 and/or 116 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

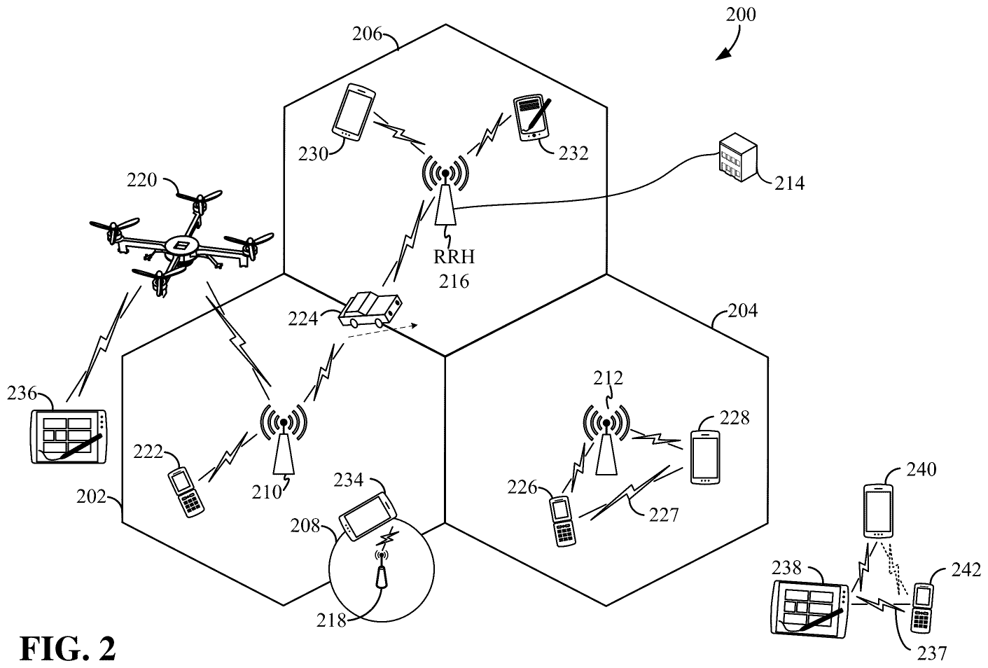

Referring now to FIG. 2, by way of example and without limitation, a schematic illustration of a radio access network (RAN) 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or network entity. FIG. 2 illustrates cells 202, 204, 206, and 208, each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various network entity arrangements can be utilized. For example, in FIG. 2, two network entities, network entity 210 and network entity 212 are shown in cells 202 and 204. A third network entity, network entity 214 is shown controlling a remote radio head (RRH) 216 in cell 206. That is, a network entity can have an integrated antenna or can be connected to an antenna or RRH 216 by feeder cables. In the illustrated example, cells 202, 204, and 206 may be referred to as macrocells, as the network entities 210, 212, and 214 support cells having a large size. Further, a network entity 218 is shown in the cell 208, which may overlap with one or more macrocells. In this example, the cell 208 may be referred to as a small cell (e.g., a microcell, picocell, femtocell, home base station, home Node B, home eNode B, etc.), as the network entity 218 supports a cell having a relatively small size. Cell sizing can be done according to system design as well as component constraints.

It is to be understood that the radio access network 200 may include any number of wireless network entities and cells. Further, a relay node may be deployed to extend the size or coverage area of a given cell. The network entities 210, 212, 214, 218 provide wireless access points to a core network for any number of mobile apparatuses. In some examples, the network entities 210, 212, 214, and/or 218 may be the same as the base station/scheduling entity 108 described above and illustrated in FIG. 1.

FIG. 2 further includes an unmanned aerial vehicle (UAV) 220, which may be a quadcopter or drone. The UAV 220 may be configured to function as a network entity (e.g., a base station). That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each network entity 210, 212, 214, 218, and 220 may be configured to provide an access point to a core network 102 (see FIG. 1) for all the UEs in the respective cells. For example, UEs 222 and 224 may be in communication with network entity 210; UEs 226 and 228 may be in communication with network entity 212; UEs 230 and 232 may be in communication with network entity 214 by way of RRH 216; UE 234 may be in communication with network entity 218; and UE 236 may be in communication with mobile network entity 220. In some examples, the UEs 222, 224, 226, 228, 230, 232, 234, 236, 238, 240, and/or 242 may be the same as the UE/scheduled entity 106 described above and illustrated in FIG. 1.

In some examples, the UAV 220 (e.g., quadcopter) may be configured to function as a UE. For example, the UAV 220 may operate within cell 202 by communicating with network entity 210.

The air interface in the RAN 200 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

Further, the air interface in the RAN 200 may utilize one or more multiplexing and multiple access algorithms to enable simultaneous communication of the various devices. For example, 5G NR specifications provide multiple access for UL transmissions from UEs 222 and 224 to network entity 210, and for multiplexing for DL transmissions from network entity 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

In a further aspect of the RAN 200, sidelink signals may be used between UEs without necessarily relying on scheduling or control information from a network entity (e.g., a base station). Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a network entity. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a network entity. In other examples, two or more UEs (e.g., UEs 226 and 228) within the coverage area of a network entity (e.g., network entity 212) may also communicate sidelink signals 227 over a direct link (sidelink) without conveying that communication through the network entity 212. In this example, the network entity 212 may allocate resources to the UEs 226 and 228 for the sidelink communication.

In some examples, a D2D relay framework may be included within a cellular network to facilitate relaying of communication to/from the network entity 212 via D2D links (e.g., sidelinks 227 or 237). For example, one or more UEs (e.g., UE 228) within the coverage area of the network entity 212 may operate as relaying UEs to extend the coverage of the network entity 212, improve the transmission reliability to one or more UEs (e.g., UE 226), and/or to allow the network entity to recover from a failed UE link due to, for example, blockage or fading.

In the RAN 200, the ability for a UE to communicate while moving, independent of its location, is referred to as mobility. The various physical channels between the UE and the RAN 200 are generally set up, maintained, and released under the control of an access and mobility management function (AMF, not illustrated, part of the core network 102 in FIG. 1), which may include a security context management function (SCMF) and a security anchor function (SEAF) that perform authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if the signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving network entity 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the network entities 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., network entities 210 and 214/216) within the radio access network 200. Each of the cells may measure a strength of the pilot signal, and the radio access network (e.g., one or more of the network entities 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may hand over the UE 224 from the serving cell to the neighboring cell, with or without informing the UE 224.

Although the synchronization signal transmitted by the network entities 210, 212, and 214/216 may be unified, the synchronization signal may not identify a particular cell, but rather may identify a zone of multiple cells operating on the same frequency and/or with the same timing. The use of zones in 5G networks or other next-generation communication networks enables the uplink-based mobility framework and improves the efficiency of both the UE and the network, since the number of mobility messages that need to be exchanged between the UE and the network may be reduced.

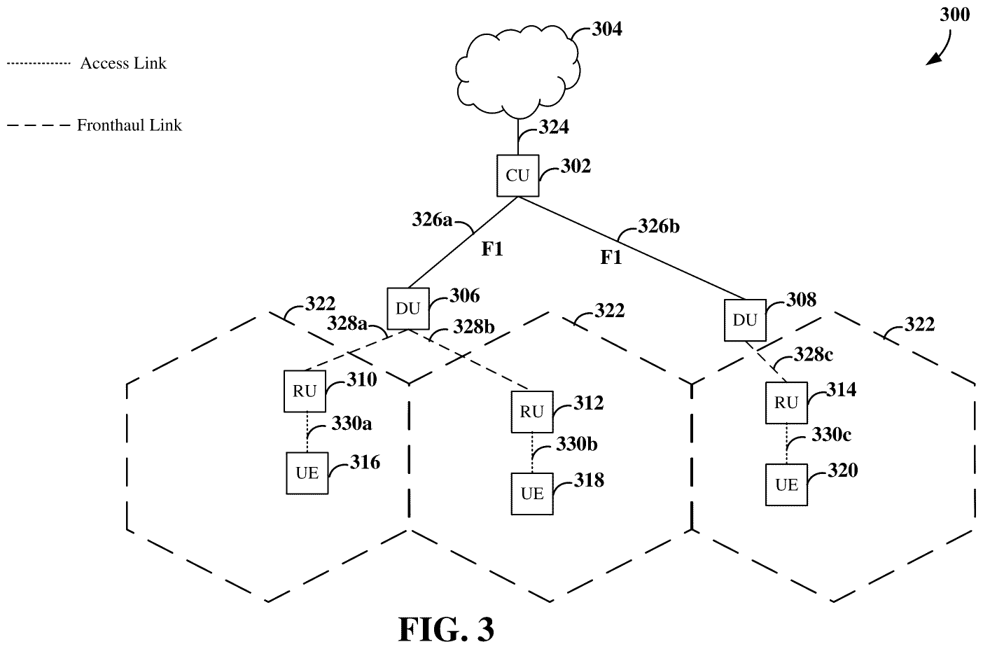

FIG. 3 is a diagram illustrating an example of a RAN 300 including distributed entities according to some aspects. The RAN 300 may be similar to the radio access network 200 shown in FIG. 2, in that the RAN 300 may be divided into a number of cells (e.g., cells 322) each of which may be served by respective network entities (e.g., control units, distributed units, and radio units). The network entities may constitute access points, TRPs, base stations (BSs), eNBs, gNBs, or other nodes that utilize wireless spectrum (e.g., the radio frequency (RF) spectrum) and/or other communication links to support access for one or more UEs located within the cells. In some examples, some or all of the network entities of FIG. 3 may be implemented within an integrated access backhaul (IAB) network. In some examples, some or all of the nodes of FIG. 3 may be implemented according to an open-radio access network (O-RAN) architecture.

In the example of FIG. 3, a control unit (CU) 302 communicates with a core network 304 via a backhaul link 324, and communicates with a first distributed unit (DU) 306 and a second DU 308 via respective midhaul links 326a and 326b. The first DU 306 communicates with a first radio unit (RU) 310 and a second RU 312 via respective fronthaul links 328a and 328b. The second DU 308 communicates with a third radio unit 314 via a fronthaul link 328c. The first RU 310 communicates with at least one UE 316 via at least one RF access link 330a. The second RU 312 communicates with at least one UE 318 via at least one RF access link 330b. The third RU 314 communicates with at least one UE 320 via at least one RF access link 330c.

In some examples, a control unit (e.g., the CU 302) is a logical node that hosts a packet data convergence protocol (PDCP) layer, a radio resource control (RRC) layer, a service data adaptation protocol (SDAP) layer and other control functions. A control unit may also terminate interfaces (e.g., an E1 interface, an E2 interface, etc., not shown in FIG. 3) to core network nodes (e.g., nodes of a core network). In addition, an F1 interface may provide a mechanism to interconnect a CU 302 (e.g., the PDCP layer and higher layers) and a DU (e.g., the radio link control (RLC) layer and lower layers). In some aspects, an F1 interface may provide control plane and user plane functions (e.g., interface management, system information management, UE context management, RRC message transfer, etc.). For example, the F1 interface may support F1-C on the control plane and F1-U on the user plane. FIAP is an application protocol for F1 that defines signaling procedures for F1 in some examples.

In some examples, a DU (e.g., the DU 306 or the DU 308) is a logical node that hosts an RLC layer, a medium access control (MAC) layer, and a high physical (PHY) layer based on a lower layer functional split (LLS). In some aspects, a DU may control the operation of at least one RU. A DU may also terminate interfaces (e.g., F1, E2, etc.) to the CU and/or other network nodes. In some examples, a high PHY layer includes portions of the PHY processing such as forward error correction 1 (FEC 1) encoding and decoding, scrambling, modulation, and demodulation.

In some examples, an RU (e.g., the RU 310, the RU 312, or the RU 314) is a logical node that hosts low PHY layer and radio frequency (RF) processing based on a lower layer functional split. In some examples, a RU may be similar to a 3GPP transmit receive point (TRP) or remote radio head (RRH), while also including the low PHY layer. In some examples, a low PHY layer includes portions of the PHY processing such as fast Fourier transform (FFT), inverse FFT (IFFT), digital beamforming, and physical random access channel (PRACH) extraction and filtering. The RU may also include a radio (e.g., radio frequency (RF)) chain for communicating with one or more UEs.

The functionality splits between the entities of the RAN 300 may be different in different examples. In some examples, Layer 1 functions, Layer 2 functions, and Layer 3 functions may be allocated among the RU, DU, and CU entities. Examples of Layer 1 functions include RF functions and low PHY layer functions. Examples of Layer 2 functions include high PHY layer functions, low MAC layer functions, high MAC layer functions, low RLC layer functions, and high RLC layer functions. Examples of Layer 3 functions include PDCP layer functions and RRC layer functions. Other functionality splits may be used in other examples.

As discussed above, the two Layer 3 functions may be implemented in a CU. The other Layer 1 and Layer 2 functions may thus be split between the RU and the DU in this case. In some examples, the Layer 1 functions are implemented in the RU and the Layer 3 functions are implemented in the DU. In some examples, all PHY functionality is implemented in the RU (i.e., the high PHY layer functions are implemented in the RU and not the DU). Other functionality splits may be used in other examples.

Different splits may be used between low layer functionality and high layer functionality in different examples. For example, the split between the low PHY layer functionality and the high PHY layer functionality may be defined between RE mapping and precoding in some cases. Thus, the RE mapping may be designated as a low PHY layer function performed by an RU and the precoding may be designated as a high PHY layer function performed by a DU in such a case. Other functionality splits may be used in other examples.

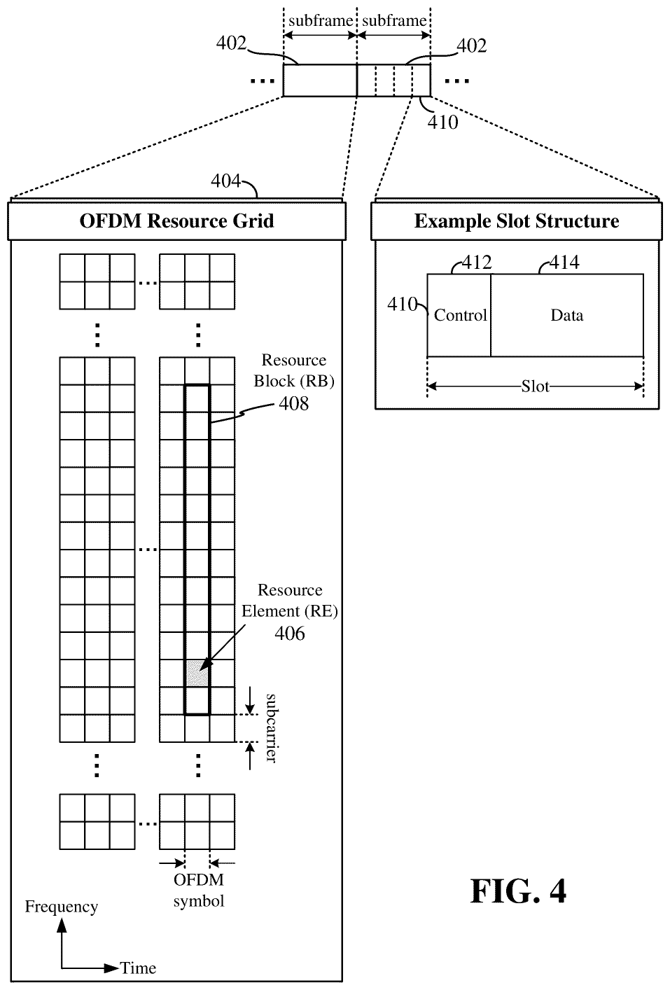

Various aspects of the present disclosure will be described with reference to an OFDM waveform, schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an exemplary subframe 402 is illustrated, showing an OFDM resource grid. However, as those skilled in the art will readily appreciate, the physical layer (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. That is, in a multiple-input-multiple-output (MIMO) implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a network entity or a base station (e.g., gNB, cNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely exemplary in nature, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 406 to carry UL control information (UCI) including one or more UL control channels, such as a physical uplink control channel (PUCCH), to the network entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., a request for the scheduling entity to schedule uplink transmissions. Here, in response to the SR transmitted on the UCI, the network entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 4 are not necessarily all of the channels or carriers that may be utilized between devices, and those of ordinary skill in the art will recognize that other channels or carriers may be utilized in addition to those illustrated, such as other traffic, control, and feedback channels.

### Cross Link Interference

Cross link interference (CLI) that interferes with wireless signals sent between devices can be caused by signal transmission from a third device. For example, CLI can occur between UEs when a network configures different TDD UL and DL slot formats to nearby UEs. When a UE (aggressor) is transmitting, another UE (victim) may receive the aggressor's transmission as CLI in its DL symbol(s) if the aggressor UE's UL symbol collides with at least one DL symbol of the victim UE. CLI can occur between two UEs on the same cell or on different cells. A UE can measure CLI when the network (e.g., gNB) configures one or more CLI measurement resources. In some aspects, the UE can be configured to perform layer 1 (L1) or layer 3 (L3) CLI measurement based on a signal (e.g., SRS) transmitted by the aggressor. For example, a CLI measurement may be reference signal received power (RSRP) or received signal strength indicator (RSSI), reference signal received quality (RSRQ) of the SRS. In some aspects, the UE can be configured to perform aperiodic, semi-periodic, and/or periodic CLI measurements, and the network can schedule periodic downlink occasions (e.g., PDCCH, PDSCH, CSI-RS, etc.) that may collide with the CLI measurements.

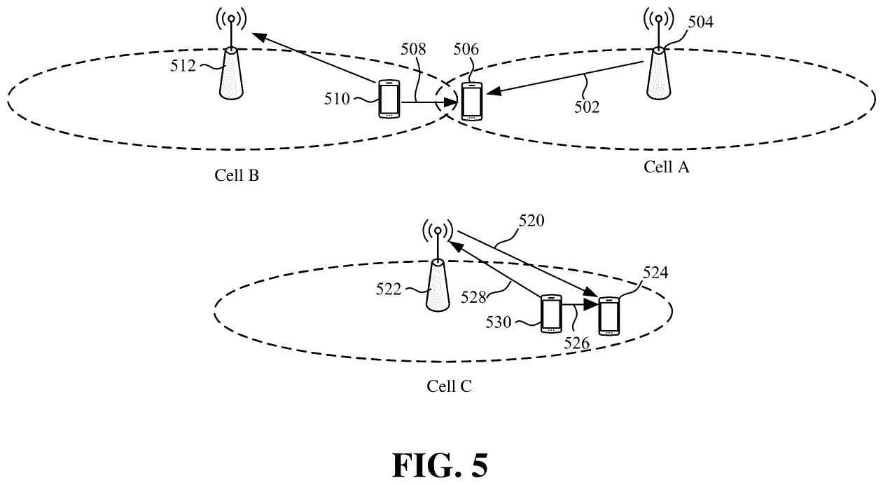

FIG. 5 is a drawing illustrating CLI examples according to some aspects. In an inter-cell CLI example, a signal transmission 502 sent from a base station 504 to a UE 506 (in cell A) can be subject to CLI 508 caused UL transmissions from a UE 510 to a base station 512. In an intra-cell CLI example, a signal transmission 520 from a base station 522 to a UE 524 can be subject to CLI 526 caused by UL transmissions 528 from another UE 530 in the same cell (Cell C). In Release 16 of the 3GPP 5G NR Specifications, a UE can skip a DL occasion when it collides with a CLI measurement occasion. However, prioritizing CLI measurement can cause many DL occasions being skipped when the CLI measurement pattern is dense. Furthermore, frequent CLI measurements can waste valuable communication resources when the UE does not experience CLI in some of the configured CLI measurement occasions.

In some aspects of the present disclosure, a UE can be configured to perform both CLI measurement and DL signal/channel reception in the same symbol time using the same fast Fourier transform (FFT) window. For example, a single FFT window can be used for both CLI measurement and DL signal/channel reception when the UL timing of aggressor and DL timing difference is small. Aspects of the disclosure provide techniques for configuring DL signals/channels (e.g., PDCCH, PDSCH, CSI-RS, etc.) to facilitate CLI measurement and DL reception using the same FFT window.

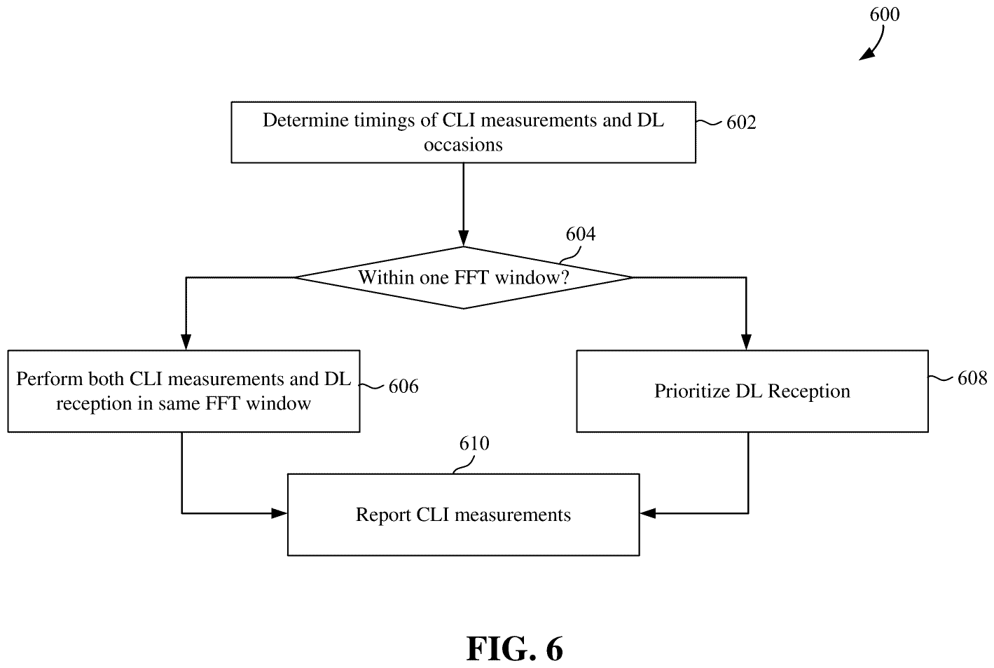

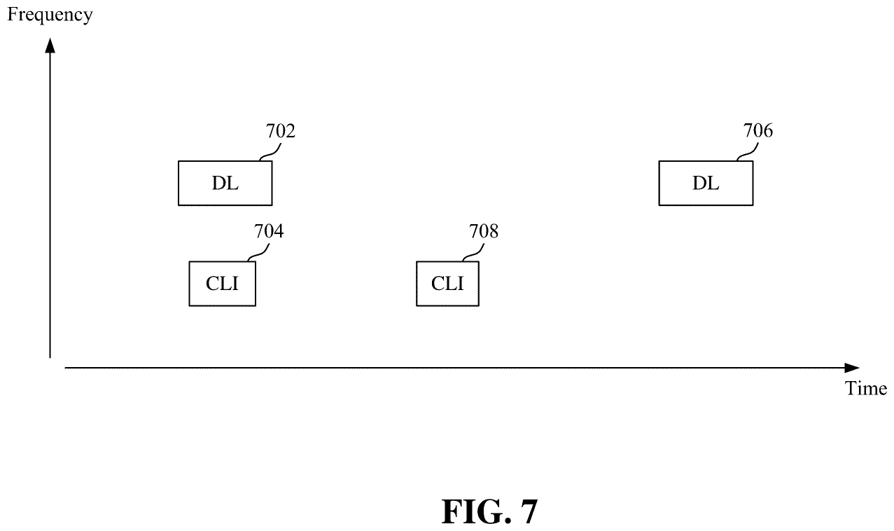

FIG. 6 is a flow chart illustrating a process 600 for controlling CLI measurement and DL reception according to some aspects of the disclosure. In one example, the process 600 can be performed by any UEs or scheduled entities described above in relation to FIGS. 1, 2, and 5. At 602, a UE can determine the timings (e.g., slots, symbols) of CLI measurement and DL occasions. Some examples of DL resources and CLI measurement resources are illustrated in FIG. 7. In one example, the UE can determine that a first DL resource 702 overlaps a first CLI measurement resource 704. In one example, the UE can determine that a second DL resource 706 does not overlap a second CLI measurement resource 708. In some examples, the UE can receive various DL signals/channels (e.g., PDSCH, PDCCH, or CSI-RS). In one example, the UE can measure a reference signal (e.g., SRS) transmitted by a nearby aggressor (e.g., UE 510 or UE 530 of FIG. 5) in using the CLI measurement resources that can be aperiodic, semi-periodic, or periodic.

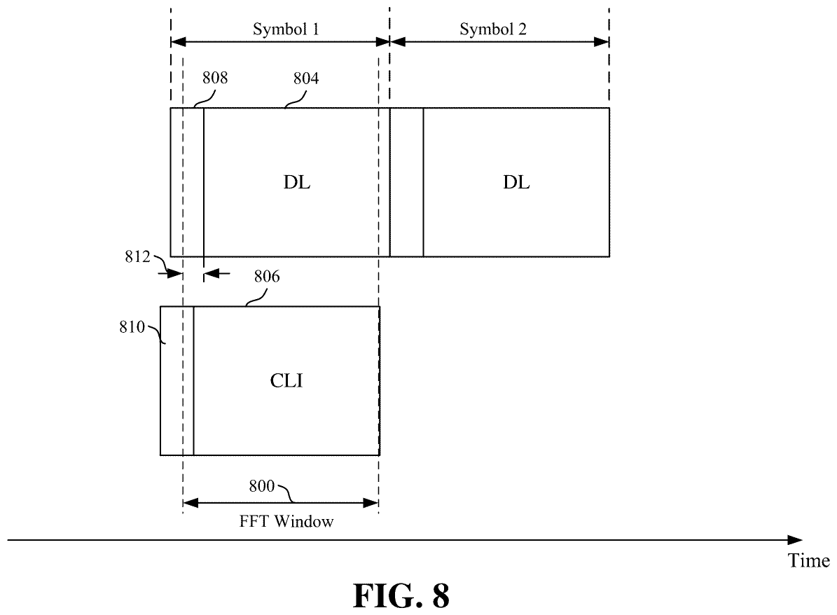

At 604, the UE can determine whether or not CLI measurement and DL reception can be performed in the same FFT window based on their timings. At 606, the UE can perform both CLI measurement and DL reception if the UE can perform both operations using the same FFT window; otherwise, at 608, the UE can prioritize a DL reception (e.g., skipping a CLI measurement). In one aspect, the UE can autonomously (i.e., without assistance or instructions from the network) determine whether CLI can be measured using the same FFT window in the same symbol where the DL signal (e.g., a PDCCH or PDSCH signal, or a CSI-RS, etc.) is received. For example, in FIG. 8, a single FFT window 800 can be used for receiving DL signal 804 and CLI measurement occasion 806 when the measurement time (e.g., FFT window 800) can start within the CPs 808/810 range of the DL signal 804 and CLI measurement occasion 806. In this case, the UE can perform both DL reception and CLI measurement in the same symbol time (e.g., symbol 1). If the CLI measurement timing is outside the CP range, the UE may skip this instance of CLI measurement 806. In one aspect, the network (e.g., gNB) can indicate a CLI timing offset (offset 812 in FIG. 8) relative to a DL signal for determining the FFT window timing. Based on the offset 812, the UE can determine whether or not CLI measurement and DL reception can be performed using the same FFT window.

In some aspects, the UE can be configured to perform a limited CLI measurement if both CLI measurement and DL reception occur in the same FFT window. For example, a normal or full CLI measurement can include both RSRP and RSSI of the CLI signal (e.g., an SRS from an aggressor). A limited CLI measurement can include only RSRP or RSSI information. Performing a limited CLI measurement can reduce the workload and/or resource requirements on the UE.

At 610, the UE can send a CLI report (e.g., CLI-RSRP report and/or CLI-RSSI report) to the network (e.g., a gNB). The CLI report can include L1 and/or L3 CLI measurements. In some aspects, the CLI report can indicate whether CLI is measured or not by the UE. In one example, when a configured CLI measurement is not performed, the CLI report can indicate “CLI report not measured” or “CLI measurements jointly encoded.” For example, jointly encoded CLI measurements can include multiple CLI measurement hypotheses and an invalid hypothesis (e.g., seven RSRP hypotheses and one invalid RSRP hypothesis). For example, data (e.g., RSRP) of multiple CLI reports can be carried in one CLI report in a UCI as a jointly encoded packet. The jointly encoded packet can include, for example, RSRP1, RSRP2, RSRP3, NA, RSRP5 of multiple CLI reports, where NA refers to an invalid RSRP hypothesis, e.g., a reserved indicator in RSRP quantization to indicate the particular report is invalid. In one example, if a CLI measurement is not performed, the UE can include the most recent CLI measurements in the CLI report.

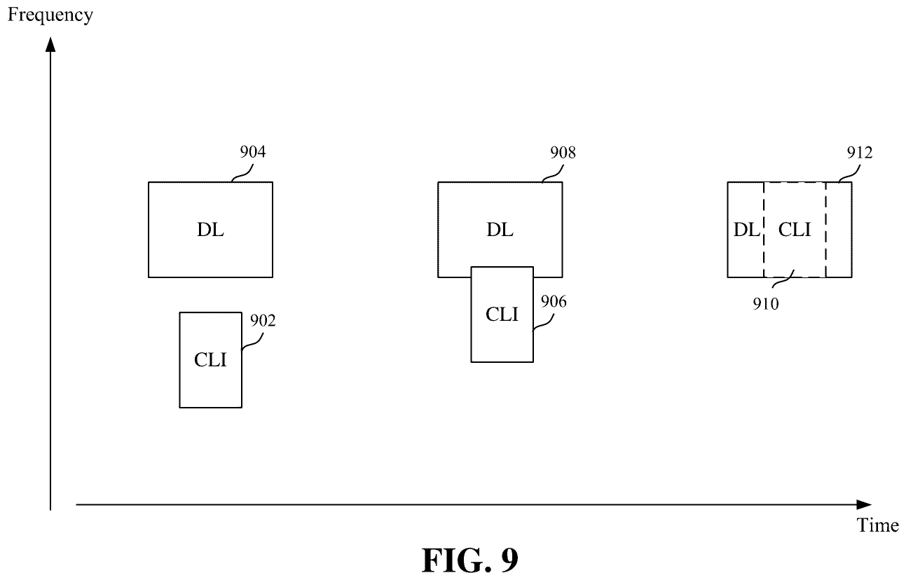

When CLI measurement (e.g., L1 and/or L3 CLI measurement) and DL resources are configured for a certain symbol or slot, CLI measurement resources (e.g., time and frequency resources, REs, RBs, subbands, etc.) may or may not overlap with the configured DL resources (e.g., PDCCH, PDSCH, CSI-RS) at the same time. A UE can be configured to perform aperiodic, semi-periodic, and/or periodic CLI measurements. FIG. 9 is a drawing illustrating some examples of configured DL resources and CLI measurement resources. In a first example, configured CLI resources 902 do not overlap DL resources 904. In a second example, configured CLI resources 906 can partially overlap DL resources 908. In a third example, configured CLI resources 910 can completely overlap DL resources 912 in the same symbol.

Aspects of the disclosure provide various techniques for enabling DL channels/signals reception and CLI measurements in the same symbol time using the same FFT window. In one aspect, a base station (e.g., gNB) can configure CLI measurement occasions and PDCCH occasions to avoid conflict in the same symbol, if possible. In one aspect, the base station can use a priority rule to configure PDSCH occasions and CLI measurement occasions to avoid conflict in the same symbol. In one aspect, the base station can use a priority rule to configure CSI reports and CLI measurements to avoid conflict in the same symbol. More detailed examples will be described below to further explain these techniques.

### PDCCH Resource and CLI Resource Configuration

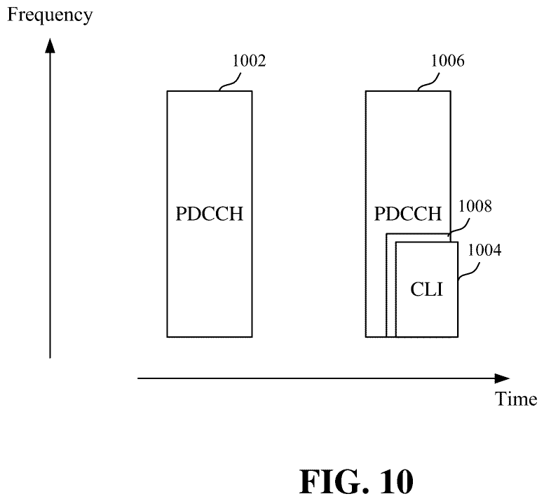

In some aspects, the network can configure CLI measurement occasions and PDCCH occasions to avoid collision between CLI measurement and PDCCH. In general, the base station (e.g., gNB) has knowledge of the timings of CLI measurement occasions and PDCCH occasions. Therefore, the base station can avoid configuring aperiodic CLI measurement resources that can conflict PDCCH resources. For example, the base station can configure PDCCH resources that do not overlap or collide with CLI measurement resources (aperiodic, semi-periodic, or periodic) when PDCCH occasions and CLI measurement occasions overlap in time (e.g., a symbol or slot). In one example, in FIG. 10, a first PDCCH 1002 can configure an aperiodic CLI measurement resources 1004 that overlaps a second PDCCH 1006 in time. The base station can avoid configuring PDCCH resources (e.g., RE groups (REGs) or CORESETs) that can overlap the CLI measurement resources 1004. In some examples, the CLI measurement resources 1004 and the PDCCH resources 1006 can be separated by a guard band 1008 (e.g., one or more REs/RBs/REGs). Similarly, for semi-periodic and periodic CLI measurements, the base station can avoid configuring PDCCH resources that can overlap or collide with semi-periodic and periodic CLI measurement resources. In one aspect, PDCCH resources can be associated with CLI measurement resources during scheduling to avoid resource conflict, for example, in the frequency domain.

### PDSCH Resource and CLI Resource Configuration

In some aspects, a base station can configure CLI measurement occasions and PDSCH occasions according to a priority rule. The priority rule defines the relative priority of aperiodic, semi-periodic, and periodic CLI measurement and PDSCH occasions. In one example, a priority rule can arrange aperiodic CLI measurement (highest priority), aperiodic PDSCH, semi-periodic CLI measurement, semi-periodic PDSCH, and periodic CLI measurement (lowest priority) in decreasing priority. In other examples, the priority rule may have other priority order combinations of CLI measurements (e.g., aperiodic, semi-periodic, and/or periodic CLI) and PDSCH (e.g., aperiodic, semi-periodic, and/or periodic PDSCH) occasions.

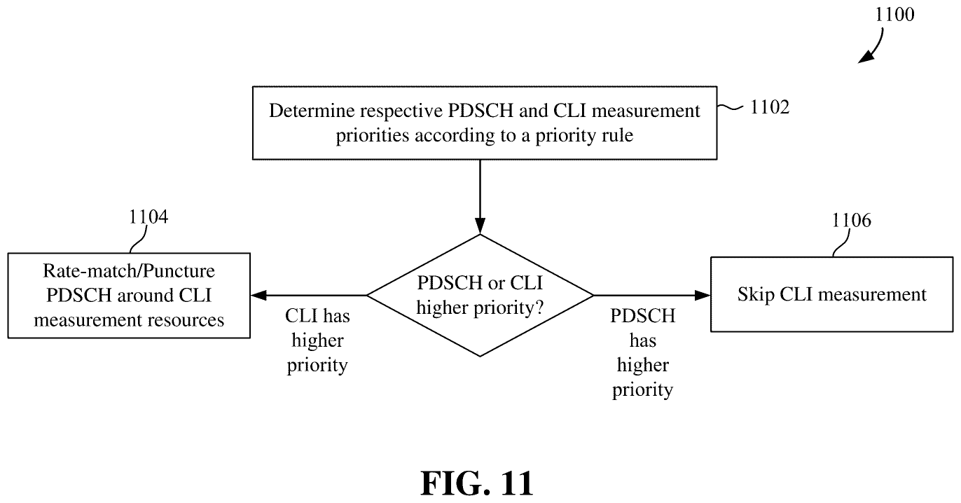

FIG. 11 is a flow chart illustrating a process 1100 for configuring PDSCH and CLI measurement occasions according to some aspects. In one example, the process 1100 may be performed by a network entity s (e.g., base stations and scheduling entities described above in relation to FIGS. 1, 2, and 5). In one aspect, the network entity (e.g., gNB) can configure a PDSCH resource and a CLI measurement resource in the same symbol. At 1102, the base station can determine the respective priorities of the PDSCH resource and CLI measurement resource according to a priority rule.

At 1104, if the CLI measurement resource has a higher priority than the PDSCH resource, the base station can rate match or puncture the PDSCH around the CLI measurement resources, for example, in the frequency domain. When rate-matching is used, the base station can rate match the data portion of PDSCH (not including the reference signal resources, for example, DMRS) around the CLI measurement resources. When puncturing is used, the base station can puncture the PDSCH data portion and reference signals (e.g., DMRS) around the CLI measurement resources. Puncturing can be made at the RE level, RB level, or physical resource block group (PRG) level. At 1106, if the PDSCH resource has a higher priority than the CLI measurement resource, the UE can skip CLI measurement.

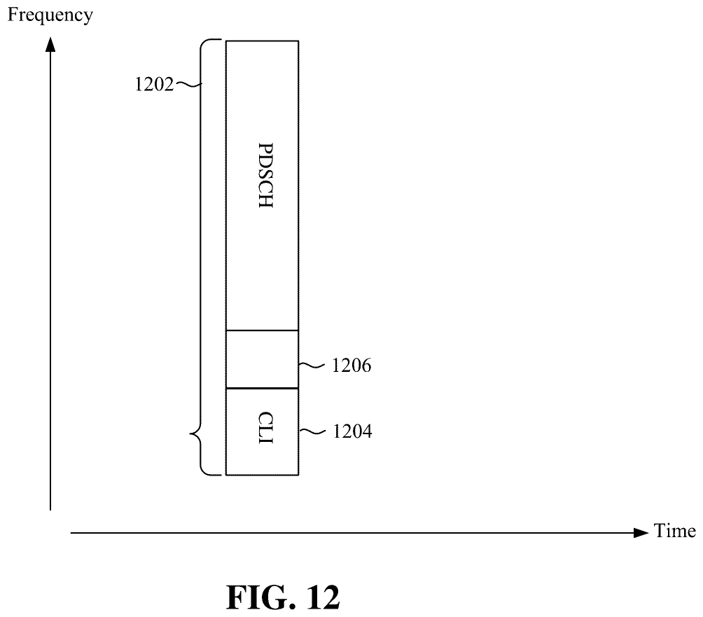

FIG. 12 illustrates exemplary PDSCH resources 1202 co-scheduled with a CLI measurement resource 1204 according to some aspects. In this example, the PDSCH resources can be rate-matched or punctured around the CLI measurement resource 1204 that takes over some resources originally used for the PDSCH 1202. In some aspects, a guard band 1206 (e.g., at RE, RB, or PRG level) may be used to separate the CLI measurement resource 1204 and the PDSCH resources to avoid interference, for example, to reduce an adjacent channel leakage ratio (ACLR). For periodic and semi-periodic CLI measurements, a CLI configuration can be associated with a PDSCH configuration. For example, the same PDCCH/DCI can trigger configured or semi-periodic PDSCH and CLI measurement. The DCI can trigger a predefined CLI measurement resource, for example, CLI resource 0, CLI resource 1, CLI resource 3, etc.

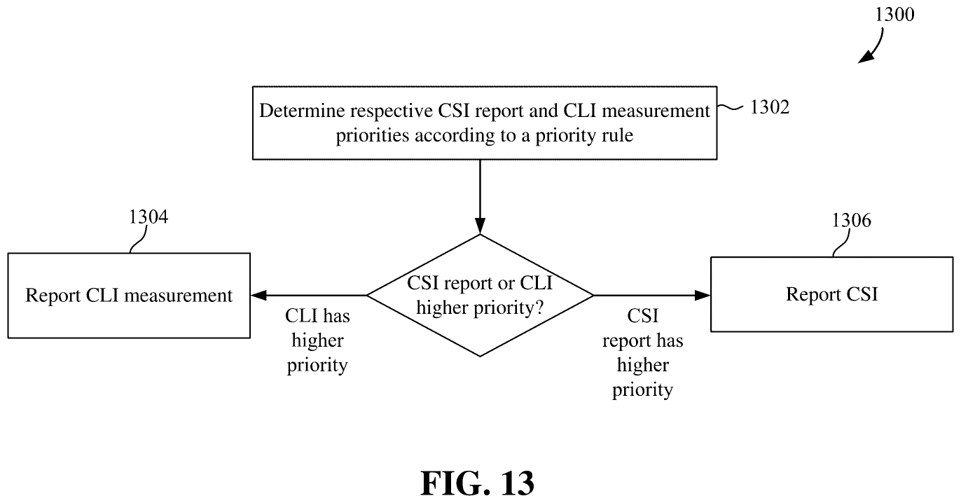

FIG. 13 is a flow chart illustrating a process 1300 for configuring channel state information (CSI) reporting and CLI measurement occasions according to some aspects. In one example, the process 1300 may be performed by a network entity (e.g., base stations and scheduling entities described above in relation to FIGS. 1, 2, and 5). In one example, the network entity (e.g., a gNB, CU) can schedule CSI reporting resources and CLI measurement resources in the same symbol. A UE can generate a CSI report based on a CSI signal transmitted by the network entity. Some examples of the CSI signal are SSB and CSI-RS. A CSI report may include CQI (Channel Quality Information), PMI (Precoding Matrix Indicator), CRI (CSI-RS Resource Indicator), LI (Layer Indicator), and/or RI (Rank Indicator).

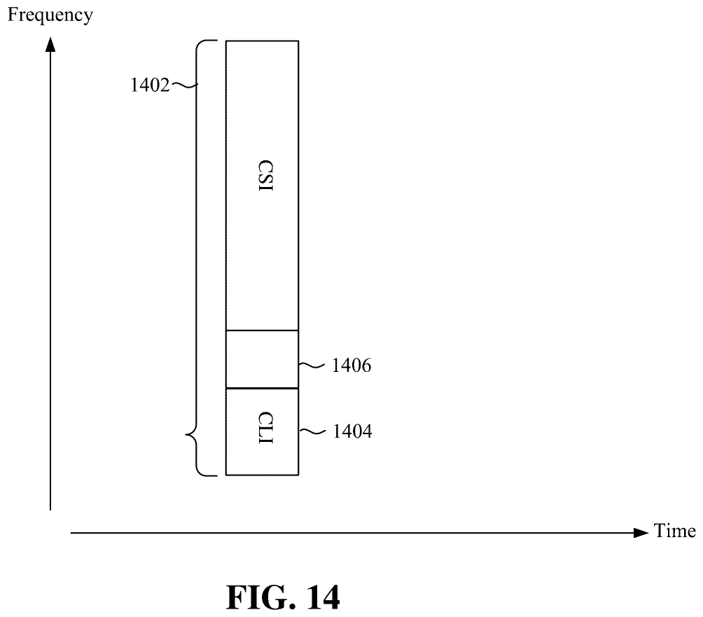

At 1302, the network entity can determine the respective priorities of CSI reporting and CLI measurement resources according to a priority rule. In one example, the priority rule can define aperiodic, semi-periodic, and periodic CLI measurement resources and CSI reporting resources in decreasing priorities as follows: aperiodic CLI measurement (highest priority), aperiodic CSI-RS, semi-periodic CLI measurement, semi-periodic CSI-RS, periodic CLI measurement, and periodic CSI-RS. In other examples, the priority rule may have other priority order combinations of aperiodic, semi-periodic, and/or periodic CLI measurement resources and aperiodic, semi-periodic, and/or periodic CSI reporting resources. In one example, in FIG. 14, the CLI measurement resources 1404 can take over some resources originally configured as CSI reporting resources 1402 when CLI and CSI resources are scheduled in the same symbol. In one aspect, the CSI reporting resources 1402 and CLI measurement resources 1404 can be separated by a guard band 1406 to avoid or reduce interference. In one example, the guard band 1406 can be configured at a RE, RB, or subband level. The guard band 1406, if used, can use some of the CLI measurement resources 1404. In some aspects, the configuration of CSI reporting resources can be associated with the configuration of CLI measurement resources. Therefore, the network entity can configure both CLI measurement resources (e.g., semi-periodic or periodic) and CSI reporting resources (e.g., semi-periodic or periodic non-zero-power (NZP) CSI-RS resources) together in the same time symbol.

At 1304, if CLI measurement resources have higher priority than CSI reporting resources, the UE can receive a CLI signal (e.g., SRS) and report CLI measurements when CLI measurement and CSI report resources are scheduled in the same time symbol. For example, if aperiodic CLI measurements have higher priority than semi-periodic CSI report according to the priority rule, the UE always performs and transmits CLI measurements (e.g., wideband or subband CLI report). In one example, if the lower priority CSI report is configured as a subband report (e.g., a subband PMI or CQI report), the UE does not report the CSI of the subband in conflict with CLI resources. In one example, if the lower priority CSI report is configured as a wideband report, where at least some CSI reporting resources (e.g., CSI-RS) are in conflict with CLI measurement resources, the UE can skip the entire CSI report (wideband CSI report) occasion. Alternatively, the UE can still report the CSI report if the CSI reporting resources collided with CLI measurement resources are less than a predetermined percentage of the configured CSI reporting resources or bandwidth.

In one example, CSI reporting resources (e.g., CSI reporting resources 1402) can be configured on a predetermined number of subbands when there is no collision with CLI measurement resources. When a collision occurs between higher priority CLI measurement resources (e.g., CLI measurement resources 1404) and lower priority CSI reporting resources, the network entity can configure CLI measurement resources to replace some CSI reporting resources in the same symbol. In one aspect, the UE can report lower priority CSI if remaining non-colliding CSI reporting resources are above a threshold (e.g., 50 percent, 75 percent, etc.); otherwise, CSI is not reported. In one example, CSI reporting resources can be configured for eight subbands in a time symbol. If higher priority CLI measurement resources use two subbands and a guard band subband, the remaining CSI reporting resources have five subbands out of the eight subbands. In this case, if the threshold is set at fifty percent, UE still reports CSI because five subbands of the CSI reporting resources are still more than fifty percent of the eight subbands originally configured for CSI reporting. However, if the threshold is set at seventy-five percent, the UE does not report CSI because five subbands of the CSI report resources are less than seventy-five percent of the eight subbands originally configured for CSI reporting.

At 1306, if CSI reporting has a higher priority than CLI measurement, the UE can always perform and report CSI when CLI measurement resources and CSI reporting resources are configured in the same time symbol. The UE may not report CLI measurement when CLI measurement resources are in conflict with CSI reporting resources. In one example, if the lower priority CLI measurement report is configured as a wideband report, where at least some CLI measurement resources are in conflict with CSI reporting resources, the UE can skip the entire CLI measurement report (e.g., wideband CLI-RSRP or CLI-RSRQ report). Alternatively, the UE can still report CLI measurement if the CLI measurement resources collided with CSI reporting resources are less than a predetermined percentage of the configured CLI measurement resources or bandwidth.

In one example, CLI measurement resources can be configured on a predetermined number of subbands when there is no collision with CLI measurement resources. When a collision occurs between higher priority CSI reporting resources and lower priority CLI measurement resources, the network entity can configure CSI reporting resources to replace some CLI measurement resources in the same symbol. In one aspect, the UE can report lower priority CLI measurements if remaining non-colliding CLI measurement resources are above a threshold (e.g., 50 percent, 75 percent, etc.); otherwise, the CLI measurement result is not reported.

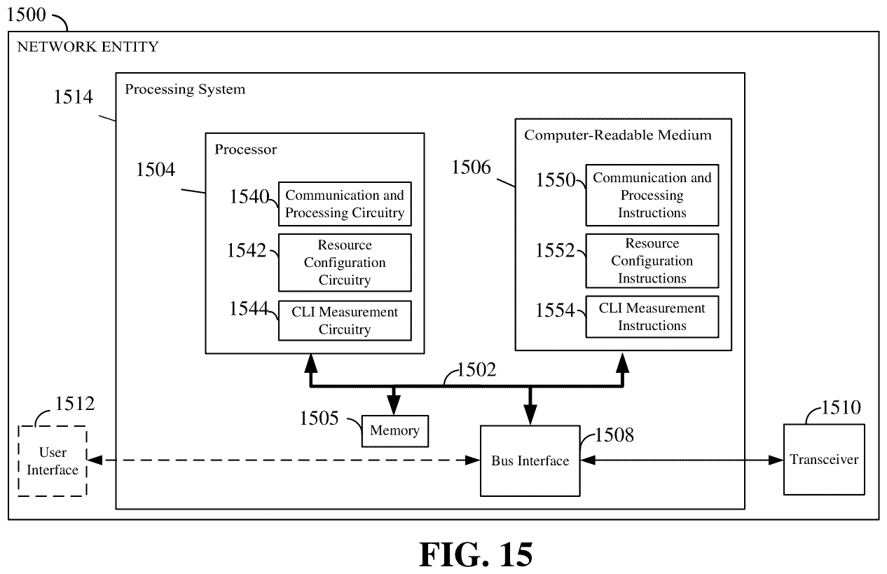

FIG. 15 is a block diagram illustrating an example of a hardware implementation for a network entity 1500 employing a processing system 1514. For example, the network entity 1500 may be a scheduling entity or base station (e.g., gNB, CU, DU) as illustrated in any one or more of FIGS. 1, 2, and/or 5.

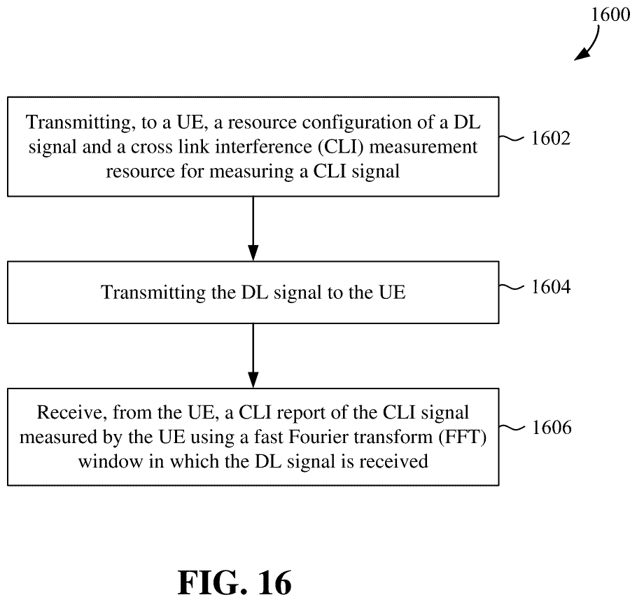

The network entity 1500 may be implemented with a processing system 1514 that includes one or more processors 1504. Examples of processors 1504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network entity 1500 may be configured to perform any one or more of the functions described herein. That is, the processor 1504, as utilized in a network entity 1500, may be used to implement any one or more of the processes and procedures described and illustrated in FIG. 16.

The processor 1504 may in some instances be implemented via a baseband or modem chip and in other implementations, the processor 1504 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 communicatively couples together various circuits including one or more processors (represented generally by the processor 1504), a memory 1505, and computer-readable media (represented generally by the computer-readable medium 1506). The bus 1502 may also link various other circuits such as timing sources, peripherals, voltage regulators, and power management circuits, which are well known in the art, and therefore, will not be described any further. A bus interface 1508 provides an interface between the bus 1502 and a transceiver 1510. The transceiver 1510 provides a communication interface or means for communicating with various other apparatus over a transmission medium. Depending upon the nature of the apparatus, a user interface 1512 (e.g., keypad, display, speaker, microphone, joystick) may also be provided. Of course, such a user interface 1512 is optional, and may be omitted in some examples, such as a network entity.

The processor 1504 is responsible for managing the bus 1502 and general processing, including the execution of software stored on the computer-readable medium 1506. The software, when executed by the processor 1504, causes the processing system 1514 to perform the various functions described below for any particular apparatus. The computer-readable medium 1506 and the memory 1505 may also be used for storing data that is manipulated by the processor 1504 when executing software.

One or more processors 1504 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1506. The computer-readable medium 1506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically crasable PROM (EEPROM), a register, a removable disk, and any other suitable medium for storing software and/or instructions that may be accessed and read by a computer. The computer-readable medium 1506 may reside in the processing system 1514, external to the processing system 1514, or distributed across multiple entities including the processing system 1514. The computer-readable medium 1506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 1504 may include circuitry configured for various functions, including, for example, functions used in wireless communication. For example, the circuitry may be configured to implement one or more of the functions described herein.

In some aspects of the disclosure, the processor 1504 may include communication and processing circuitry 1540 configured for various functions, including for example communicating with a network core (e.g., a 5G core network), scheduled entities (e.g., UE), or any other entity, such as, for example, local infrastructure or an entity communicating with the network entity 1500 via the Internet, such as a network provider. In some examples, the communication and processing circuitry 1540 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1540 may include one or more transmit/receive chains. In addition, the communication and processing circuitry 1540 may be configured to receive and process uplink traffic and uplink control messages (e.g., similar to uplink traffic 116 and uplink control 118 of FIG. 1), transmit and process downlink traffic and downlink control messages (e.g., similar to downlink traffic 112 and downlink control 114). The communication and processing circuitry 1540 may further be configured to execute communication and processing software 1550 stored on the computer-readable medium 1506 to implement one or more functions described herein.

In some implementations where the communication involves receiving information, the communication and processing circuitry 1540 may obtain information from a component of the network entity 1500 (e.g., from the transceiver 1510 that receives the information via radio frequency signaling or some other type of signaling suitable for the applicable communication medium), process (e.g., decode) the information, and output the processed information. For example, the communication and processing circuitry 1540 may output the information to another component of the processor 1504, to the memory 1505, or to the bus interface 1508. In some examples, the communication and processing circuitry 1540 may receive one or more of signals, messages, other information, or any combination thereof. In some examples, the communication and processing circuitry 1540 may receive information via one or more channels. In some examples, the communication and processing circuitry 1540 may include functionality for a means for receiving. In some examples, the communication and processing circuitry 1540 may include functionality for a means for processing, including a means for demodulating, a means for decoding, etc.

In some implementations where the communication involves sending (e.g., transmitting) information, the communication and processing circuitry 1540 may obtain information (e.g., from another component of the processor 1504, the memory 1505, or the bus interface 1508), process (e.g., modulate, encode, etc.) the information, and output the processed information. For example, the communication and processing circuitry 1540 may output the information to the transceiver 1510 (e.g., that transmits the information via radio frequency signaling or some other type of signaling suitable for the applicable communication medium). In some examples, the communication and processing circuitry 1540 may send one or more of signals, messages, other information, or any combination thereof. In some examples, the communication and processing circuitry 1540 may send information via one or more channels. In some examples, the communication and processing circuitry 1540 may include functionality for a means for sending (e.g., a means for transmitting). In some examples, the communication and processing circuitry 1540 may include functionality for a means for generating, including a means for modulating, a means for encoding, etc.

In some aspects of the disclosure, the processor 1504 may include resource configuration circuitry 1542 configured for various functions. The resource configuration circuitry 1542 can be configured to determine the communication resources (e.g., time-frequency resources) for measuring UL/DL communications and CLI measurement. In one example, the network entity 1500 can use the resource configuration circuitry 1542 to configure and schedule aperiodic, semi-periodic, and/or periodic resources for measuring a CLI signal (e.g., an SRS) from an aggressor (e.g., UE or base station). In one example, the network entity 1500 can use the resource configuration circuitry 1542 to configure and schedule aperiodic, semi-periodic, and/or periodic resources for CSI reporting, PDSCH, and PDCCH. The resource configuration circuitry 1542 may further be configured to execute resource configuration software 1552 stored on the computer-readable medium 1506 to implement one or more functions described herein.

In some aspects of the disclosure, the processor 1504 may include CLI measurement circuitry 1544 configured for various functions, for example, CLI measurements. In one example, the network entity 1500 can use the CLI measurement circuitry 1544 to process a CLI measurement report received from a UE or a neighbor network entity. The CLI measurement circuitry 1544 can be configured to provide the CLI measurements to the resource configuration circuitry 1542 that can take CLI into consideration when scheduling resources for the UE. In some examples, the network entity 1500 may provide the CLI measurement report to neighboring network entities (e.g., a gNB, an eNB, CU, DU, etc.). The CLI measurement circuitry 1544 may further be configured to execute CLI measurement software 1554 stored on the computer-readable medium 1506 to implement one or more functions described herein.

FIG. 16 is a flow chart illustrating an exemplary process 1600 for downlink communication and CLI measurements in accordance with some aspects of the present disclosure. As described below, some or all illustrated features may be omitted in a particular implementation within the scope of the present disclosure, and some illustrated features may not be required for the implementation of all examples. In some examples, the process 1600 may be carried out by the network entity 1500 illustrated in FIG. 15. In some examples, the process 1600 may be carried out by any suitable apparatus or means for carrying out the functions or algorithm described below.

At block 1602, a network entity (e.g., a gNB or scheduling entity) can transmit a resource configuration to a UE. The resource configuration can indicate the configured resource for receiving a DL signal and a CLI measurement resource for measuring a CLI signal at the UE. In one aspect, the communication and processing circuitry 1540 can provide a means to transmit the resource configuration to the UE using the transceiver 1510. In one aspect, the resource configuration circuitry 1542 can provide a means to determine the resources (e.g., time-frequency resources) for the DL signal and CLI measurements. In some aspects, the CLI measurement resource can be aperiodic, semi-periodic, or periodic resources for receiving and measuring a CLI signal from an aggressor (e.g., an SRS from a nearby UE).

At block 1604, the network entity can transmit the DL signal to the UE using the configured DL resource. In one aspect, the communication and processing circuitry 1540 can provide a means to transmit the DL signal using the transceiver 1510. In some examples, the DL signal can be a PDSCH signal, a PDCCH signal, or a CSI signal (e.g., SSB, CSI-RS). The network entity can transmit the DL signal in a symbol in which the UE is configured to measure the CLI signal using the configured CLI measurement resource.

At block 1606, the network entity can receive, from the UE, a CLI report of the CLI signal measured by the UE using an FFT window in which the DL signal is received by the UE. In one aspect, the communication and processing circuitry 1540 can provide a means to receive the CLI report using the transceiver 1510. In some aspects, the network entity may change its scheduling strategy based on the CLI report. In one example, the CLI measurement circuitry 1544 can provide a means to proceed the CLI report and provide the results to the resource configuration circuitry 1542. In some aspects, the network entity may also forward the CLI report to a neighboring network entity (e.g., gNB, cNB, CU, DU, etc.) to facilitate CLI reduction between UEs and/or network entities.

In one aspect, the network entity can transmit the DL signal in a PDCCH using configured DL resources (e.g., PDCCH resources 1006) that are not in conflict with the CLI signal. In one aspect, the network entity can transmit the DL signal in a PDSCH using resources (e.g., PDSCH resource 1202) that are rate-matched or punctured around the CLI measurement resource (e.g., CLI measurement resource 1204) or CLI signal based on a priority rule associated with the DL signal and the CLI signal, for example, as described above in relation to FIG. 11.

In one aspect, the DL signal can include a CSI reference signal (e.g., CSI-RS). In one aspect, the network entity can transmit the CSI reference signal using configured CSI reporting resources (e.g., CSI reporting resource 1402). The network entity can receive a CSI report when a collision between the CSI reference signal and the CLI signal is less than a predetermined threshold in terms of configured resources. In one aspect, the network entity can receive the CLI report when a collision between the CSI reference signal and the CLI signal is less than a predetermined threshold in terms of configured resources.

In one configuration, the network entity 1500 can include means for performing the wireless communication functions described above in relation to FIG. 16. In one aspect, the aforementioned means may be the processor 1504 shown in FIG. 15 configured to perform the functions recited by the aforementioned means. In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable storage medium 1506, or any other suitable apparatus or means described in any one of the FIGS. 1, 2, and/or 5, and utilizing, for example, the processes and/or algorithms described herein in relation to FIGS. 6-14.

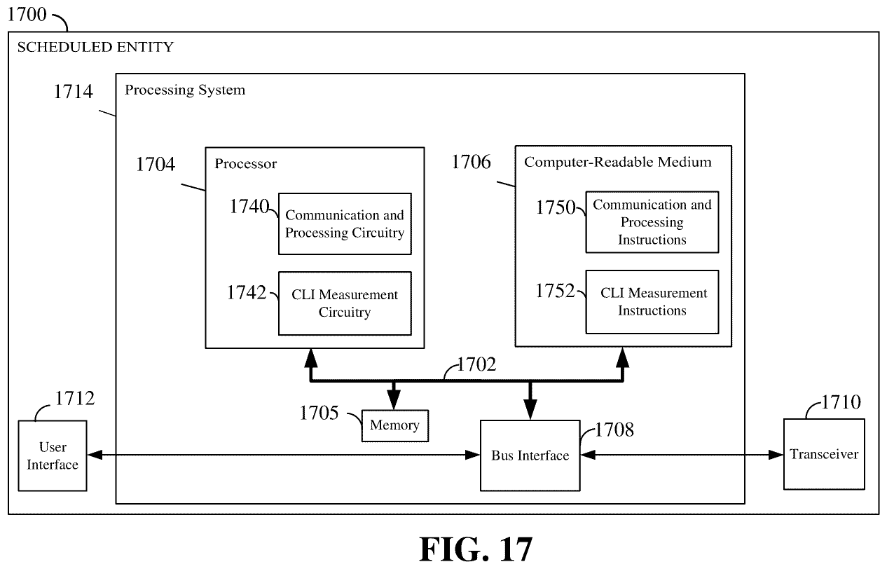

FIG. 17 is a diagram illustrating an example of a hardware implementation for an exemplary scheduled entity 1700 employing a processing system 1714. In accordance with various aspects of the disclosure, an element, or any portion of an element, or any combination of elements may be implemented with a processing system 1714 that includes one or more processors 1704. For example, the scheduled entity 1700 may be a user equipment (UE) as illustrated in any one or more of FIGS. 1, 2, and/or 5.

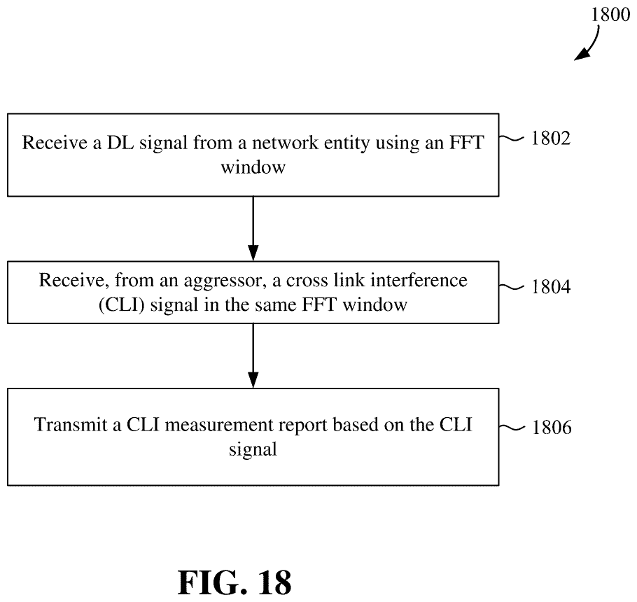

The processing system 1714 may be substantially the same as the processing system 1514 illustrated in FIG. 15, including a bus interface 1708, a bus 1702, memory 1705, a processor 1704, and a computer-readable medium 1706. Furthermore, the scheduled entity 1700 may include a user interface 1712 and a transceiver 1710 substantially similar to those described above in FIG. 14. That is, the processor 1704, as utilized in a scheduled entity 1700, may be used to implement any one or more of the processes described and illustrated in FIG. 18.

In some aspects of the disclosure, the processor 1704 may include circuitry configured for various functions, including, for example, UL/DL wireless communication and CLI measurements. For example, the circuitry may be configured to implement one or more of the functions described herein.

In some aspects of the disclosure, the processor 1704 may include communication and processing circuitry 1740 configured for various functions, including for example communicating with a network node (e.g., a base station, a gNB, an eNB, etc.) In some examples, the communication and processing circuitry 1740 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1740 may include one or more transmit/receive chains. In addition, the communication and processing circuitry 1740 may be configured to transmit and process uplink traffic and uplink control messages (e.g., similar to uplink traffic 116 and uplink control 118 of FIG. 1), receive and process downlink traffic and downlink control messages (e.g., similar to downlink traffic 112 and downlink control 114). The communication and processing circuitry 1740 may further be configured to execute communication and processing software 1750 stored on the computer-readable medium 1706 to implement one or more functions described herein.

In some implementations where the communication involves receiving information, the communication and processing circuitry 1740 may obtain information from a component of the scheduled entity 1700 (e.g., from the transceiver 1710 that receives the information via radio frequency signaling or some other type of signaling suitable for the applicable communication medium), process (e.g., decode) the information, and output the processed information. For example, the communication and processing circuitry 1740 may output the information to another component of the processor 1704, to the memory 1705, or to the bus interface 1708. In some examples, the communication and processing circuitry 1740 may receive one or more of signals, messages, other information, or any combination thereof. In some examples, the communication and processing circuitry 1740 may receive information via one or more channels. In some examples, the communication and processing circuitry 1740 may include functionality for a means for receiving. In some examples, the communication and processing circuitry 1740 may include functionality for a means for processing, including a means for demodulating, a means for decoding, etc.

In some implementations where the communication involves sending (e.g., transmitting) information, the communication and processing circuitry 1740 may obtain information (e.g., from another component of the processor 1704, the memory 1705, or the bus interface 1708), process (e.g., modulate, encode, etc.) the information, and output the processed information. For example, the communication and processing circuitry 1740 may output the information to the transceiver 1710 (e.g., that transmits the information via radio frequency signaling or some other type of signaling suitable for the applicable communication medium). In some examples, the communication and processing circuitry 1740 may send one or more signals, messages, other information, or any combination thereof. In some examples, the communication and processing circuitry 1740 may send information via one or more channels. In some examples, the communication and processing circuitry 1740 may include functionality for a means for sending (e.g., a means for transmitting). In some examples, the communication and processing circuitry 1740 may include functionality for a means for generating, including a means for modulating, a means for encoding, etc.

In some aspects of the disclosure, the processor 1704 may include CLI measurement circuitry 1742 configured for various functions, for example, measurement of a CLI signal from an aggressor (e.g., a nearby UE). For example, the CLI measurement circuitry 1742 can be configured to process a CLI signal (e.g., SRS) that is received in the same FFT window for receiving a DL signal (e.g., a PDCCH, PDSCH, or CSI reference signal) and generate a CLI measurement report of the CLI signal. For example, the CLI measurement report may include a CLI-RSRP report and/or CLI-RSSI report. In some examples, the CLI measurement circuitry 1742 may be configured to execute CLI measurement software 1752 stored on the computer-readable medium 1706 to implement one or more functions described herein.

FIG. 18 is a flow chart illustrating an exemplary process 1800 for wireless communication in accordance with some aspects of the present disclosure. As described below, some or all illustrated features may be omitted in a particular implementation within the scope of the present disclosure, and some illustrated features may not be required for the implementation of all examples. In some examples, the process 1800 may be carried out by the scheduled entity 1700 (e.g., a UE) illustrated in FIG. 17. In some examples, the process 1800 may be carried out by any suitable apparatus or means for carrying out the functions or algorithm described below.

At block 1802, a UE can receive a DL signal from a network entity using an FFT window. In one aspect, the communication and processing circuitry 1740 can provide a means to receive the DL signal from the network entity using the transceiver 1710. In some aspects, the DL signal can be a PDSCH signal, a PDCCH signal, or a CSI signal (e.g., CSI-RS).

At block 1804, the UE can receive a CLI signal in the same FFT window from an aggressor. In one aspect, the communication and processing circuitry 1740 can provide a means to receive the CLI signal using the transceiver 1710. For example, the CLI signal may be a signal (e.g., SRS) transmitted by a nearby UE (aggressor) in the same cell or a different cell. In some aspects, the UE can be configured to receive the DL signal and the CLI signal in the same symbol or time slot in which the UE is configured to measure the CLI signal using configured CLI measurement resource (e.g., CLI measurement occasion 806). In some examples, the UE can be configured to receive the DL signal using DL resources (e.g., PDCCH resources 1006, PDSCH resources 1202, or CSI reporting resources 1402) that may overlap, partially or completely, with CLI measurement resources for receiving the CLI signal.

At block 1806, the UE can transmit a CLI measurement report to the network entity. In one aspect, the communication and processing circuitry 1740 can provide a means to transmit the CLI measurement report. The CLI measurement report (e.g., CLI-RSRP, CLI-RSSI, and/or CLI-RSRQ report) can be based on the CLI signal that is received in the same FFT window for receiving the DL signal. In one aspect, the CLI measurement circuitry 1742 can provide a means to process the CLI signal and generate the CLI measurement report based on the CLI signal.

In one aspect, the UE can determine a timing difference between the DL signal and the CLI signal, for example, as described above in relation to FIG. 4. Then, the UE can determine to receive the DL signal and the CLI signal using the same FFT window when the timing difference is less than a predetermined threshold. In one aspect, the CLI measurement report can include an indicator (e.g., a field) that indicates whether or not CLI measurement is performed on the CLI signal. In one aspect, the DL signal can include at least one of a PDCCH signal, a PDSCH signal, or a CSI reference signal. In one aspect, the UE can receive the DL signal in a PDSCH using resources rate-matched or punctured around the CLI signal based on a priority rule associated with the DL signal and the CLI signal.

In one aspect, the UE can receive DL control information (e.g., PDCCH/DCI) from the network entity. The DL control information can indicate a first resource for receiving the DL signal and a second resource for receiving the CLI signal. In one example, the first resource and the second resource are not overlapped in a frequency domain. In one aspect, the first resource and the second resource may be separated by a guard band.

In one aspect, the DL signal can include a CSI reference signal, and the UE can transmit a CSI report of the CSI reference signal based on a priority rule that indicates respective priorities of the CSI reference signal and the CLI signal. In one aspect, the UE can determine to transmit the CSI report when a collision between the CSI reference signal and the CLI signal is less than a predetermined threshold in terms of configured resources. In one aspect, the UE can determine to transmit the CLI measurement report when a collision between the CSI reference signal and the CLI signal is less than a predetermined threshold in terms of configured resources.

In one configuration, the apparatus (scheduled entity) 1700 for wireless communication includes means for performing the functions described herein. In one aspect, the aforementioned means may be the processor 1704 shown in FIG. 17 configured to perform the functions recited by the aforementioned means. In another aspect, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions stored in the computer-readable storage medium 1706, or any other suitable apparatus or means described in any one of the FIGS. 1, 2, and/or 5, and utilizing, for example, the processes and/or algorithms described herein in relation to FIGS. 4-14 and 18.

In a first aspect, a user equipment (UE) for wireless communication is provided. The UE comprises: a transceiver for wireless communication; a memory; and a processor coupled to the transceiver and the memory, wherein the processor and the memory are configured to: receive, from a network entity, a downlink (DL) signal using a fast Fourier transform (FFT) window; receive, from an aggressor, a cross link interference (CLI) signal in the same FFT window; and transmit, to the network entity, a CLI measurement report based on the CLI signal.

In a second aspect, alone or in combination with the first aspect, wherein the processor and the memory are further configured to: determine a timing difference between the DL signal and the CLI signal; and determine to receive the DL signal and the CLI signal using the same FFT window when the timing difference is less than a predetermined threshold.

In a third aspect, alone or in combination with the first aspect, wherein the CLI measurement report comprises an indicator that indicates whether or not CLI measurement is performed on the CLI signal.

In a fourth aspect, alone or in combination with any of the first to third aspects, the DL signal comprises at least one of a physical downlink control channel (PDCCH), a physical downlink shared channel (PDSCH), or a channel state information (CSI) reference signal; and the CLI signal comprises a sounding reference signal (SRS).

In a fifth aspect, alone or in combination with any of the first to third aspects, wherein the processor and the memory are further configured to receive the DL signal in a physical downlink shared channel (PDSCH) using resources rate-matched or punctured around the CLI signal based on a priority rule associated with the DL signal and the CLI signal.

In a sixth aspect, alone or in combination with any of the first to third aspects, wherein the processor and the memory are further configured to: receive, for the network entity, DL control information indicating a first resource for receiving the DL signal and a second resource for receiving the CLI signal, wherein the first resource and the second resource are not overlapped in a frequency domain.

In a seventh aspect, alone or in combination with the sixth aspect, wherein the first resource and the second resource are separated by a guard band.

In an eighth aspect, alone or in combination with any of the first to third aspects, wherein the DL signal comprises a channel state information (CSI) reference signal, and the processor and the memory are further configured to transmit a CSI report of the CSI reference signal based on a priority rule that indicates respective priorities of the CSI reference signal and the CLI signal.

In a ninth aspect, alone or in combination with the eighth aspect, wherein the processor and the memory are further configured to determine to transmit the CSI report when a collision between the CSI reference signal and the CLI signal is less than a predetermined threshold in terms of configured resources.

In a tenth aspect, alone or in combination with the eighth aspect, wherein the processor and the memory are further configured to determine to transmit the CLI measurement report when a collision between the CSI reference signal and the CLI signal is less than a predetermined threshold in terms of configured resources.

In an eleventh aspect, a method of wireless communication at a user equipment (UE) is provided. The method comprises: receiving, from a network entity, a downlink (DL) signal using a fast Fourier transform (FFT) window; receiving, from an aggressor, a cross link interference (CLI) signal in the same FFT window; and transmitting a CLI measurement report based on the CLI signal.

In a twelfth aspect, alone or in combination with the eleventh aspect, the method further comprises: determining a timing difference between the DL signal and the CLI signal; and determining to receive the DL signal and the CLI signal using the same FFT window when the timing difference is less than a predetermined threshold.

In a thirteenth aspect, alone or in combination with the eleventh aspect, wherein the CLI measurement report comprises an indicator that indicates whether or not CLI measurement is performed on the CLI signal.

In a fourth aspect, alone or in combination with any of the eleventh to thirteenth aspects, wherein: the DL signal comprises at least one of a physical downlink control channel (PDCCH), a physical downlink shared channel (PDSCH), or a channel state information (CSI) reference signal; and the CLI signal comprises a sounding reference signal (SRS).

In a fifteenth aspect, alone or in combination with any of the eleventh to thirteenth aspects, wherein the receiving the DL signal comprises: receiving the DL signal in a physical downlink shared channel (PDSCH) using resources rate-matched or punctured around the CLI signal based on a priority rule associated with the DL signal and the CLI signal.

In a sixteenth aspect, alone or in combination with any of the eleventh to thirteenth aspects, the method further comprises: receiving, for the network entity, DL control information indicating a first resource for receiving the DL signal and a second resource for receiving the CLI signal, wherein the first resource and the second resource are not overlapped in a frequency domain.

In a seventeenth aspect, alone or in combination with the sixteenth aspect, wherein the first resource and the second resource are separated by a guard band.

In an eighteenth aspect, alone or in combination with any of the eleventh to thirteenth aspects, wherein the DL signal comprises a channel state information (CSI) reference signal, the method further comprising: transmitting a CSI report of the CSI reference signal based on a priority rule that indicates respective priorities of the CSI reference signal and the CLI signal.

In a nineteenth aspect, alone or in combination with the eighteenth aspect, the method further comprises: determining to transmit the CSI report when a collision between the CSI reference signal and the CLI signal is less than a predetermined threshold in terms of configured resources.

In a twentieth aspect, alone or in combination with the eighteenth aspect, wherein the transmitting the CLI measurement report comprises: determining to transmit the CLI measurement report when a collision between the CSI reference signal and the CLI signal is less than a predetermined threshold in terms of configured resources.

In a twenty-first aspect, a network entity for wireless communication is provided. The network entity comprises: a transceiver for wireless communication; a memory; and a processor coupled to the transceiver and the memory, wherein the processor and the memory are configured to: transmit, to a user equipment (UE), a resource configuration of a downlink (DL) signal and a cross link interference (CLI) measurement resource for measuring a CLI signal from an aggressor; transmit the DL signal to the UE; and receive, from the UE, a CLI report of the CLI signal measured by the UE using a fast Fourier transform (FFT) window in which the DL signal is received.

In a twenty-second aspect, alone or in combination with the twenty-first aspect, wherein the processor and the memory are further configured to transmit the DL signal in a physical downlink control channel (PDCCH) using resources configured by the resource configuration not in conflict with the CLI signal.

In a twenty-third aspect, alone or in combination with any of the twenty-first to twenty-second aspects, wherein the processor and the memory are further configured to transmit the DL signal in a physical downlink shared channel (PDSCH) using resources rate-matched or punctured around the CLI measurement resource based on a priority rule associated with the DL signal and the CLI signal.

In a twenty-fourth aspect, alone or in combination with the twenty-first aspect, wherein the DL signal comprises a channel state information (CSI) reference signal, and the processor and the memory are further configured to receive a CSI report when a collision between the CSI reference signal and the CLI signal is less than a predetermined threshold in terms of configured resources.

In a twenty-fifth aspect, alone or in combination with the twenty-first aspect, wherein the DL signal comprises a channel state information (CSI) reference signal, and the processor and the memory are further configured to receive the CLI report when a collision between the CSI reference signal and the CLI signal is less than a predetermined threshold in terms of configured resources.

In a twenty-sixth aspect, a method of wireless communication at a network entity is provided. The method comprises: transmitting, to a user equipment (UE), a resource configuration of a downlink (DL) signal and a cross link interference (CLI) measurement resource for measuring a CLI signal from an aggressor; transmitting the DL signal to the UE; and receiving, from the UE, a CLI report of the CLI signal measured by the UE using a fast Fourier transform (FFT) window in which the DL signal is received.

In a twenty-seventh aspect, alone or in combination with the twenty-sixth aspect, wherein the transmitting the DL signal comprises: transmitting the DL signal in a physical downlink control channel (PDCCH) using resources configured by the resource configuration not in conflict with the CLI signal.

In a twenty-eighth aspect, alone or in combination with any of the twenty-sixth to twenty-seventh aspects, wherein the transmitting the DL signal comprises: transmitting the DL signal in a physical downlink shared channel (PDSCH) using resources rate-matched or punctured around the CLI measurement resource based on a priority rule associated with the DL signal and the CLI signal.

In a twenty-ninth aspect, alone or in combination with the twenty-sixth aspect, wherein the DL signal comprises a channel state information (CSI) reference signal, the method further comprising: receiving a CSI report when a collision between the CSI reference signal and the CLI signal is less than a predetermined threshold in terms of configured resources.

In a thirtieth aspect, alone or in combination with the twenty-sixth aspect, wherein the DL signal comprises a channel state information (CSI) reference signal, and wherein the receiving the CLI report comprises receiving the CLI report when a collision between the CSI reference signal and the CLI signal is less than a predetermined threshold in terms of configured resources.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-18 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-18 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

What is claimed is:

1. A user equipment (UE) for wireless communication, comprising:
a transceiver for wireless communication;
a memory; and
a processor coupled to the transceiver and the memory,
wherein the processor and the memory are configured to:
receive, from a network entity, a downlink (DL) signal using a fast Fourier transform (FFT) window;
receive a cross link interference (CLI) signal in the same FFT window; and
transmit, to the network entity, a CLI measurement report based on the CLI signal.

2. The UE of claim 1, wherein the processor and the memory are further configured to:
determine a timing difference between the DL signal and the CLI signal; and
determine to receive the DL signal and the CLI signal using the same FFT window when the timing difference is less than a predetermined threshold.

3. The UE of claim 1, wherein the CLI measurement report comprises an indicator that indicates whether or not CLI measurement is performed on the CLI signal.

4. The UE of claim 1, wherein:
the DL signal comprises at least one of a physical downlink control channel (PDCCH), a physical downlink shared channel (PDSCH), or a channel state information (CSI) reference signal; and
the CLI signal comprises a sounding reference signal (SRS).

5. The UE of claim 1, wherein the processor and the memory are further configured to:
receive the DL signal in a physical downlink shared channel (PDSCH) using resources rate-matched or punctured around the CLI signal based on a priority rule associated with the DL signal and the CLI signal.

6. The UE of claim 1, wherein the processor and the memory are further configured to:
receive, for the network entity, DL control information indicating a first resource for receiving the DL signal and a second resource for receiving the CLI signal, wherein the first resource and the second resource are not overlapped in a frequency domain.

7. The UE of claim 6, wherein the first resource and the second resource are separated by a guard band.

8. The UE of claim 1, wherein the DL signal comprises a channel state information (CSI) reference signal, and the processor and the memory are further configured to:
transmit a CSI report of the CSI reference signal based on a priority rule that indicates respective priorities of the CSI reference signal and the CLI signal.

9. The UE of claim 8, wherein the processor and the memory are further configured to:
determine to transmit the CSI report when a collision between the CSI reference signal and the CLI signal is less than a predetermined threshold in terms of configured resources.

10. The UE of claim 8, wherein the processor and the memory are further configured to:
determine to transmit the CLI measurement report when a collision between the CSI reference signal and the CLI signal is less than a predetermined threshold in terms of configured resources.

11. A method of wireless communication at a user equipment (UE), comprising
receiving, from a network entity, a downlink (DL) signal using a fast Fourier transform (FFT) window;
receiving a cross link interference (CLI) signal in the same FFT window; and
transmitting a CLI measurement report based on the CLI signal.

12. The method of claim 11, further comprising:
determining a timing difference between the DL signal and the CLI signal; and
determining to receive the DL signal and the CLI signal using the same FFT window when the timing difference is less than a predetermined threshold.

13. The method of claim 11, wherein the CLI measurement report comprises an indicator that indicates whether or not CLI measurement is performed on the CLI signal.

14. The method of claim 11, wherein:
the DL signal comprises at least one of a physical downlink control channel (PDCCH), a physical downlink shared channel (PDSCH), or a channel state information (CSI) reference signal; and
the CLI signal comprises a sounding reference signal (SRS).

15. The method of claim 11, wherein the receiving the DL signal comprises:
receiving the DL signal in a physical downlink shared channel (PDSCH) using resources rate-matched or punctured around the CLI signal based on a priority rule associated with the DL signal and the CLI signal.

16. The method of claim 11, further comprising:
receiving, for the network entity, DL control information indicating a first resource for receiving the DL signal and a second resource for receiving the CLI signal, wherein the first resource and the second resource are not overlapped in a frequency domain.

17. The method of claim 16, wherein the first resource and the second resource are separated by a guard band.

18. The method of claim 11, wherein the DL signal comprises a channel state information (CSI) reference signal, further comprising:
transmitting a CSI report of the CSI reference signal based on a priority rule that indicates respective priorities of the CSI reference signal and the CLI signal.

19. The method of claim 18, further comprising:
determining to transmit the CSI report when a collision between the CSI reference signal and the CLI signal is less than a predetermined threshold in terms of configured resources.

20. The method of claim 18, wherein the transmitting the CLI measurement report comprises:
determining to transmit the CLI measurement report when a collision between the CSI reference signal and the CLI signal is less than a predetermined threshold in terms of configured resources.

21. A network entity for wireless communication, comprising:
a transceiver for wireless communication;
a memory; and
a processor coupled to the transceiver and the memory,
wherein the processor and the memory are configured to:
transmit a resource configuration of a downlink (DL) signal and a cross link interference (CLI) measurement resource for measuring a CLI signal;
transmit the DL signal; and
receive a CLI report of the CLI signal measured by a user equipment (UE) using a fast Fourier transform (FFT) window in which the DL signal is received.

22. The network entity of claim 21, wherein the processor and the memory are further configured to:
transmit the DL signal in a physical downlink control channel (PDCCH) using resources configured by the resource configuration not in conflict with the CLI signal.

23. The network entity of claim 21, wherein the processor and the memory are further configured to:
transmit the DL signal in a physical downlink shared channel (PDSCH) using resources rate-matched or punctured around the CLI measurement resource based on a priority rule associated with the DL signal and the CLI signal.

24. The network entity of claim 21, wherein the DL signal comprises a channel state information (CSI) reference signal, and
the processor and the memory are further configured to receive a CSI report when a collision between the CSI reference signal and the CLI signal is less than a predetermined threshold in terms of configured resources.

25. The network entity of claim 21, wherein the DL signal comprises a channel state information (CSI) reference signal, and
the processor and the memory are further configured to receive the CLI report when a collision between the CSI reference signal and the CLI signal is less than a predetermined threshold in terms of configured resources.

26. A method of wireless communication at a network entity, comprising:
transmitting a resource configuration of a downlink (DL) signal and a cross link interference (CLI) measurement resource for measuring a CLI signal;
transmitting the DL signal; and
receiving a CLI report of the CLI signal measured by a user equipment (UE) using a fast Fourier transform (FFT) window in which the DL signal is received.

27. The method of claim 26, wherein the transmitting the DL signal comprises:
transmitting the DL signal in a physical downlink control channel (PDCCH) using resources configured by the resource configuration not in conflict with the CLI signal.

28. The method of claim 26, wherein the transmitting the DL signal comprises:
transmitting the DL signal in a physical downlink shared channel (PDSCH) using resources rate-matched or punctured around the CLI measurement resource based on a priority rule associated with the DL signal and the CLI signal.

29. The method of claim 26, wherein the DL signal comprises a channel state information (CSI) reference signal, further comprising:
receiving a CSI report when a collision between the CSI reference signal and the CLI signal is less than a predetermined threshold in terms of configured resources.

30. The method of claim 26,
wherein the DL signal comprises a channel state information (CSI) reference signal, and
wherein the receiving the CLI report comprises receiving the CLI report when a collision between the CSI reference signal and the CLI signal is less than a predetermined threshold in terms of configured resources.
